(19) United States
(12) Patent Application Publication
(10) Pub. No.: US 2006/0150529 A1
(43) Pub. Date: Jul. 13, 2006

(54) Weather protection system

(76) Inventors: Thomas W. Hogg JR., Taneytown, MD (US); Christopher M. Dugan, Eldersburg, MD (US)

Correspondence Address: J. Bruce Hoofnagle, P.O. Box 370, Lisbon, MD, 21765-0370, US

(21) Appl. No.: 11/329,584

(22) Filed: Jan. 11, 2006

Related U.S. Application Data
(60) Provisional application No. 60/642,552, filed on Jan. 11, 2005.

(51) Int. Cl. E06B 1/04; B62D 63/04

(52) U.S. Cl. 52/3; 52/204.1

(57) ABSTRACT

A protective cover 98 is stored adjacent a right side wall 48 of a structure 42 for use in protecting the structure during adverse weather conditions. A cable 74 is attached to a bar 102 at a leading portion of the cover 98. The cable 74 extends over a roof 52 of the structure 42, and is attached to a reel 64 adjacent a left side wall 50. Lift arms 208 and 208a are located adjacent a front and rear wall, respectively, for pivoting movement about intermediate sections of the front and rear walls. The lift arms 208 and 208a are coupled to the bar 102. As the reel 64 is operated, the cover 98 is pulled toward the structure 42, and the lift arms 208 and 208a raise the cover above the structure.

This application claims the benefit of U.S. Provisional Application No. 60/642,552 filed Jan. 11, 2005, which is incorporated herein by reference thereto.

### BACKGROUND OF THE INVENTION

This invention relates to a weather protection system, and relates particularly to a system for shielding a structure during adverse weather conditions.

It is commonplace for severe wind and rain storms, such as hurricanes, tornadoes, cyclones and the like, to develop in areas of tropic, or near tropic, temperatures. Storms of this nature have led to major damage to, and even the destruction of, structures, such as residential houses, trailers, commercial buildings, and the like, which are located in the path of such storms. While such adverse weather conditions develop, and are encountered, in many parts of the world, their destructive forces are particularly prevalent in the island countries located in the Caribbean Sea, and portions of countries which border the contiguous waters of the Caribbean Sea, the Gulf of Mexico, and the northwestern shoreline of the Atlantic Ocean.

Several states along the southern and eastern border of the United States of America are frequently subjected to such adverse weather conditions. It is well known that, for many years, storms of this nature have caused widespread structural devastation, resulting in personal tragedies including homelessness, injury and even death.

Some systems have been considered in the past, which are intended to shield and protect various types and sizes of structures from weather-related, or fire-related damage and destruction. Several examples of such systems are disclosed in a group of five U.S. patents, identified as U.S. Pat. Nos. 3,715,843; 5,791,090; 5,881,499; 6,088,975 and 6,865,852.

In general, each of the above-noted group of five patents discloses a protective cover located on, and secured about, a structure to provide a protective shield for the structure. However, each of the group of five patents do not disclose any facility for placing the cover over the structure.

Another U.S. Pat. No. 5,748,072 shows a system for placement of a fire protective cover over a structure. Generally, the system includes a foldable frame formed by a plurality of ribs, which supports the cover, with the ribs pivoted in an arcing fashion about a common point to place the cover above, and over, the structure, in a quonset-hut-like arrangement. However, the system does not show any facility for placement of the cover onto the structure, or for securance of the edges of the cover.

In another example of a protective cover for a structure, U.S. Pat. No. 6,453,621 shows a complex wind protection system for unreeling a flexible netting from a netting reel, and placing the netting over the structure. A first end of each of a pair of spaced netting cables is attached to the netting reel, adjacent a first side of the structure, and the cables extend along, and are attached to, opposite sides of the reeled flexible netting. Leading portions of the pair of cables extend from the reeled netting, over respective rotatable pulleys mounted on top of a pair of motor-driven, vertically extendable poles. Leading portions of each of the pair of cables extend to a second end thereof, which is attached to a respective one of a pair of spaced cable reels, located adjacent a second side of the structure. The pair of cables are operatively attached to the netting reel and the cable reel by a pair of cable winches.

Upon operation of the system shown in U.S. Pat. No. 6,453,621, the poles are extended vertically upward from a collapsed position to a raised position, whereby the pair of rotatable pulleys and the leading portions of the pair of spaced cables are raised above the height of the structure. Upon operation of the winches, the netting is guided above, and over, the structure, and to the second side of the structure.

Ultimately, side portions of the netting, and portions of the pair of cables, which are attached to the side portions of the netting, pass over the rotatable pulleys. With continued operation of the winches, the cables, including the portions attached to the sides of the netting, are drawn tighter by the cable reels resulting in forced downward movement of the poles to the collapsed position, and a tensioning of the netting around the structure.

The complex system disclosed in U.S. Pat. No. 6,453,621 includes a plurality of sets of power-driving devices, with successive sets being operated in a sequential manner to effectively deploy the netting over the structure. Further, the system includes a pair of cables attached to the sides of the flexible netting, with the netting and the sections of the cables attached to the netting being stored on a common netting reel. Also, while the system shows securance of the netting at the netting reel, the cable reels and adjacent the winches, the system does not show facility for securance of other portions of the edges of the netting.

Thus, there is a need for an unobtrusive, uncomplicated weather protection system which readily facilitates placement of a protective cover over, and onto, a structure in an efficient and protective manner. There is a further need for a weather protection system for placing a protective cover over and onto a structure, with facility for securing the edges of the cover to preclude entry of weather-related elements within the cover, and thereby preclude damage to the structure.

### SUMMARY OF THE INVENTION

It is, therefore, an object of the preferred embodiment of this invention to provide a facility for placement of a protective cover, and ont, a structure in an efficient and protective manner.

Another object of the preferred embodiment of this invention is to provide facility for securing edges of a protective cover on a structure to preclude entry of weather related elements within the cover.

With these and other objects in mind, the preferred embodiment of this invention contemplates a weather protection system for use with a structure to be shielded from adverse weather conditions. In the preferred embodiment, a weather protective cover having an attachment portion is locatable adjacent a first section of the structure when the weather protective cover is in a structure-uncovering position. Means are located at least partially adjacent a second section of the structure spaced from the first section thereof, with at least a portion of the structure being between the first section and the second section, and connectible to the attachment portion of the weather protective cover for pulling the attachment portion, and thereby the weather protective cover, to a structure-covering position whereby the weather protective cover is over the at least a portion of the structure. Other means, connectible to the attachment portion of the weather protective cover, and responsive to the pulling of the attachment portion from the structure-uncovering position to the structure-covering position, spatially lift the weather protective cover over the at least a portion of the structure.

The preferred embodiment of this invention further contemplates the attachment portion being a rigid bar, which is attached to at least a portion of a leading edge of the weather protective cover.

It is further contemplated in the preferred embodiment of this invention that the means for pulling the attachment portion includes a cable reel, a drive motor which is coupled drivingly to the cable reel, and a cable having a first end attachable to the attachment portion of the weather protective cover, and a second end attachable to the cable reel.

It is also contemplated in the preferred embodiment of this invention that the means for spatially lifting the weather protective cover includes a first lift arm having a forward end and a trailing end, the forward end of the first lift arm being attachable to a first section of the attachment portion, the trailing end of the first lift arm being mountable to facilitate pivoting movement of the first lift arm, a second lift arm spaced from the first lift arm, and having a forward end and a trailing end, the forward end of the second lift arm being attachable to a second section of the attachment portion, spaced from the first section thereof; and the trailing end of the second lift arm being mountable to facilitate pivoting movement of the second lift arm.

The preferred embodiment of this invention further contemplates that the trailing ends of the first lift arm and the second lift arm are locatable intermediate the first section of the structure and the second section of the structure, and on opposite respective sides of the portions of the structure which extend between the first and second sections thereof.

Also, the preferred embodiment of the embodiment of this invention contemplate that each of the first lift arm and the second lift arm includes a first channel bar, a second channel bar mounted in engagement with, and for sliding movement relative to, the first channel bar, and a bar-lock assembly for locking the first channel bar with the second channel bar, to preclude sliding movement therebetween.

In addition, the preferred embodiment of this invention contemplates a rigid bar, which forms the attachment portion, and which is attached to at least a portion of a leading edge of the weather protective cover. The forward ends of each of the first lift arm and the second lift arm are coupled to the rigid bar to allow relative movement of the forward ends relative to the rigid bar, while maintaining the coupling between the forward ends and the rigid bar.

The preferred embodiment of this invention additionally contemplates a first locking member fixedly mounted at a location adjacent the structure where the trailing end of the first lift arm is locatable. A first pivot mount is removably assembled with the first locking member, and the trailing end of the first lift arm is attachable to the first pivot mount. A second locking member is fixedly mounted at a location adjacent the structure where the trailing end of the second lift arm is locatable. A second pivot mount is removably assembled with the second locking member, and the trailing end of the second lift arm is attachable to the second pivot mount.

Further, the preferred embodiment of the invention contemplates a lip receptor which is mounted fixedly adjacent and spaced from the portion of the structure between the first and second sections thereof. A locking lip is formed continuously along at least a portion of a side edge of the weather protective cover, and the locking lip is locatable within the lip receptor to removably retain the at least a portion of the side edge with the fixedly mounted lip receptor.

The preferred embodiment of this invention additionally contemplates that the lip receptor includes a longitudinal sleeve, and a longitudinal slit which is formed in the sleeve, through which the locking lip of the weather protective cover is inserted to removably retain the side edge of the weather protective cover with the fixedly mounted lip receptor.

Further, the preferred embodiment of this invention contemplates that the locking lip includes a strip which is integrally formed along an inboard edge thereof with, and extending longitudinally along, a contiguous portion of the weather protective cover. The strip is folded laterally along the inboard edge and over an adjacent surface of the contiguous portion of the weather protective cover. The strip assumes a normal position, where the strip is angularly displaced from the adjacent surface of the contiguous portion of the weather protective cover by a prescribed locking angle. The strip is bendable from the normal position toward the adjacent surface of the contiguous portion of the weather protective cover upon application of an outside force, and is biased to return to the normal position when the outside force is removed.

The preferred embodiment of this invention further includes a drainage trough located adjacent, and spaced from, the at least a portion of the structure between the first section and the second section of the structure.

Also, the preferred embodiment of this invention contemplates a drainage trough which is located adjacent, and spaced from, the at least a portion of the structure between the first section and the second section of the structure, and the lip receptor is integral with the drainage trough.

The preferred embodiment of this invention also contemplates a weather protection system for use with a structure, which has a prescribed height, to shield the structure from adverse weather conditions, and further includes a weather protective cover which is maintained in a structure-uncovering position prior to being positioned in a structure-covering position onto the structure; Means are provided for moving the weather protective cover from the structure-uncovering position to the structure-covering position onto the structure. A cover-following lifting mechanism is coupled to a leading section of the weather protective cover, and is structured to follow movement of the weather protective cover as the weather protective cover is being moved by the means for moving. The cover-following lifting mechanism is structured to raise at least the leading section of the weather protective cover to a height greater than the prescribed height as portions of the weather protective cover are moved over the structure.

Additionally, the preferred embodiment of this invention contemplates a storage container for storing the weather protective cover in the structure-uncovering position.

Further, the preferred embodiment of this invention includes a rigid bar which is attached to at least a portion of the leading section of the weather protective cover. A pivot member, which is fixedly mounted on a portion of the rigid bar, has a support section extending outward from the rigid bar. The cover-following lifting mechanism has a portion mounted on the support section of the pivot member. Means are provided for allowing movement of the cover-following lifting mechanism about the support section and relative to the rigid bar while the portion of the cover-following lifting mechanism is mounted on the support section.

Still further, the preferred embodiment of this invention contemplates a weather protection system, which includes a weather protective cover locatable onto the structure, and a lip receptor mounted fixedly adjacent, and spaced from at least a portion of, the structure. A locking lip is formed continuously along at least a portion of a side edge of the weather protective cover, and the locking lip is locatable within the lip receptor to removably retain the at least a portion of the side edge with the fixedly mounted lip receptor.

The preferred embodiment of this invention also includes means for moving the weather protective cover from a structure-uncovering position to a structure-covering position onto the structure. A cover-following lifting mechanism is coupled to a leading section of the weather protective cover, and is structured to follow movement of the weather protective cover as the weather protective cover is being moved by the means for moving. The cover-following lifting mechanism is structured to raise at least the leading section of the weather protective cover above the structure as the weather protective cover is moved over the structure.

### BRIEF DESCRIPTION OF THE DRAWINGS

In the accompanying drawings:

FIG. 1 is a perspective view showing a structure in conjunction with a weather protection system in accordance with certain principles of the invention;

FIG. 2 is a top view showing the layout of the weather protection system and the structure of FIG. 1 in accordance with certain principles of the invention;

FIG. 3 is a perspective view showing a vault or storage container, with a right side wall removed, for storing a reeled, weather protective cover in accordance with certain principles of the invention;

FIG. 4 is a perspective view showing the storage container of FIG. 3 with a front wall removed to reveal the reeled weather protective cover of FIG. 3 stored in the vault in accordance with certain principles of the invention;

FIG. 5 is a front view showing a biased, reel center support for supporting a central portion of the reeled weather protective cover within the vault of FIG. 3 in accordance with certain principles of the invention;

FIG. 6 is a side view showing the biased reel center support of FIG. 5 in assembly with layers of the reeled cover of FIG. 3 in accordance with certain principles of the invention;

FIG. 7 is a partial perspective view showing a rigid bar attached to at least a portion of a leading edge of the cover of FIG. 3, a coupling attachment secured to a central portion of the rigid bar, and with an end of the bar in assembly with a leading end of a first channel bar, which is slidably located within a second channel bar, of a lift arm, in accordance with certain principles of the invention;

FIG. 8 is sectional perspective view showing the assembly of the leading end of the first channel bar of FIG. 7 with the rigid bar of FIG. 7, and the coupling attachment of FIG. 7 secured to the central portion of the rigid bar in accordance with certain principles of the invention;

FIG. 9 is perspective view showing a coupling attachment formed by a single piece of stranded cable with a clinched closed loop in the center thereof and clinched closed loops at opposite ends thereof in accordance with certain principles of the invention;

FIG. 10 is a perspective view showing a portion of the first channel bar located adjustably within the second channel bar of the lift arm of FIG. 7 in a locked state in accordance with certain principles of the invention;

FIG. 11 is an end view showing the second channel bar of FIG. 8 in assembly with the first channel bar of FIG. 8, with the second channel bar being formed with inward-turned, interfacing, longitudinal ledges to retain the first channel bar with the second channel bar, and further showing the first and second channel bars in the locked state, in accordance with certain principles of the invention;

FIG. 12 is a perspective view showing, in phantom, a pivot rod attached to a trailing end of the second channel bar of FIG. 8, with a center linking section of the pivot rod located in a pivot mount, shown in solid, to facilitate pivoting of the second channel bar relative to the pivot mount in accordance with certain principles of the invention;

FIG. 13 is a sectional view showing a locking member for the pivot mount of FIG. 12 in accordance with certain principles of the invention;

FIG. 14 is a top view showing features of the locking member of FIG. 13 in accordance with certain principles of the invention;

FIG. 15 is a front view showing the pivot mount of FIG. 12 with locking rods extending therefrom for securing the pivot mount to the locking member of FIG. 13 in accordance with certain principles of the invention;

FIG. 16 is a partial perspective view showing an anchor and drainage trough with “weep” holes and drainage ports, and an open-sided anchor sleeve, in accordance with certain principles of the invention;

FIG. 17 is a partial perspective view of the anchor and drainage trough of FIG. 16 located and secured within a trench formed in the ground adjacent the structure of FIG. 1, with a locking lip of the cover of FIG. 3 assembled within the open-sided anchor sleeve of FIG. 16 in accordance with certain principles of the invention;

FIG. 18 is a partial perspective view showing an enlarged representation of the locking lip of the cover of FIG. 3 in assembly with the open-sided anchor sleeve of FIG. 16 in accordance with certain principles of the invention;

FIG. 19 is a partial view showing a plurality of clips attached to the edge of the cover of FIG. 3, which are insertable into openings formed in the first and second channel bars of FIG. 7 to facilitate assembling the edge of the cover with the channels in accordance with certain principles of the invention;

FIG. 20 is a perspective view showing the cover of the weather protection system of FIG. 1 in a first phase of being deployed over the structure in accordance with certain principles of the invention;

FIG. 21 is a perspective view showing the cover of the weather protection system of FIG. 1 in a second phase of being deployed over the structure in accordance with certain principles of the invention;

FIG. 22 is a perspective view showing the cover of the weather protection system of FIG. 1 in a third phase of being deployed over the structure in accordance with certain principles of the invention;

FIG. 23 is a perspective view showing the cover of the weather protection system of FIG. 1 in a fourth phase of being deployed over the structure in accordance with certain principles of the invention; and

FIG. 24 is a perspective view showing the cover of the weather protection system of FIG. 1 in a fifth, and final, phase of being deployed over the structure wherein the cover is fully deployed in accordance with certain principles of the invention.

### DETAILED DESCRIPTION OF THE PREFERRED EMBODIMENTS OF THE INVENTION

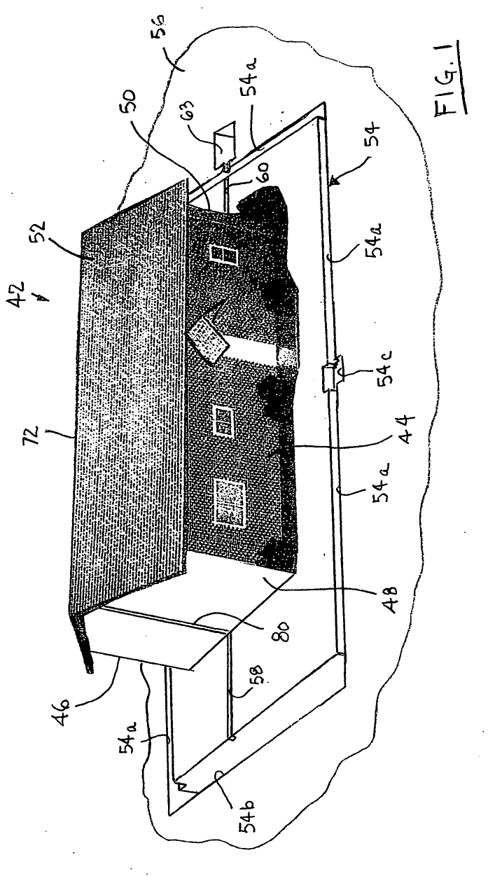

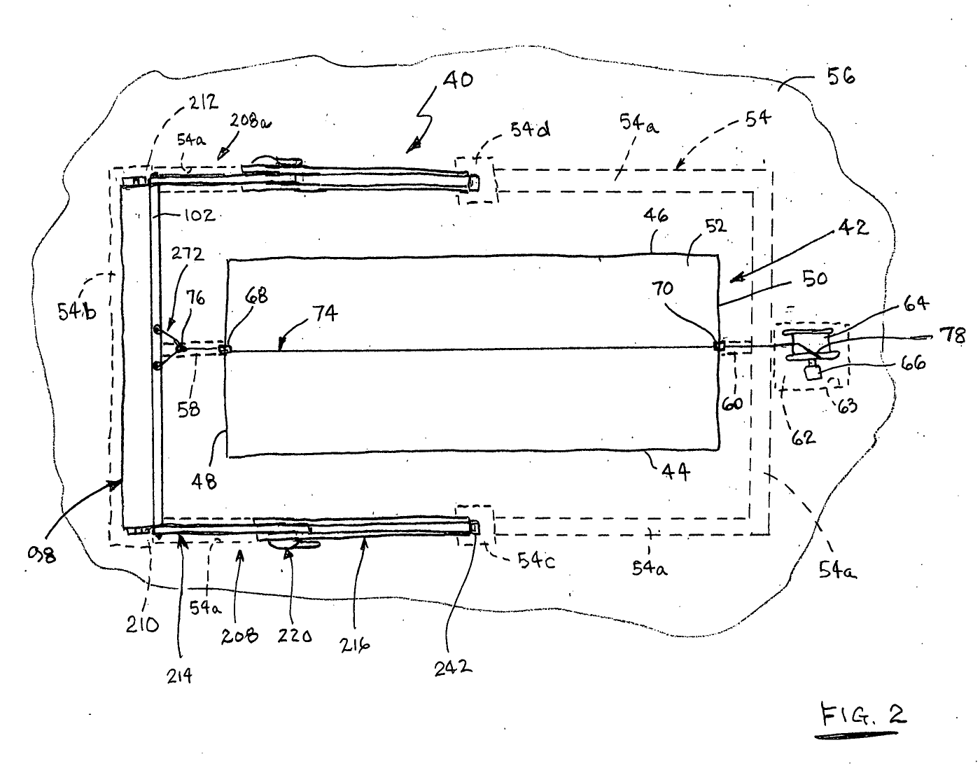

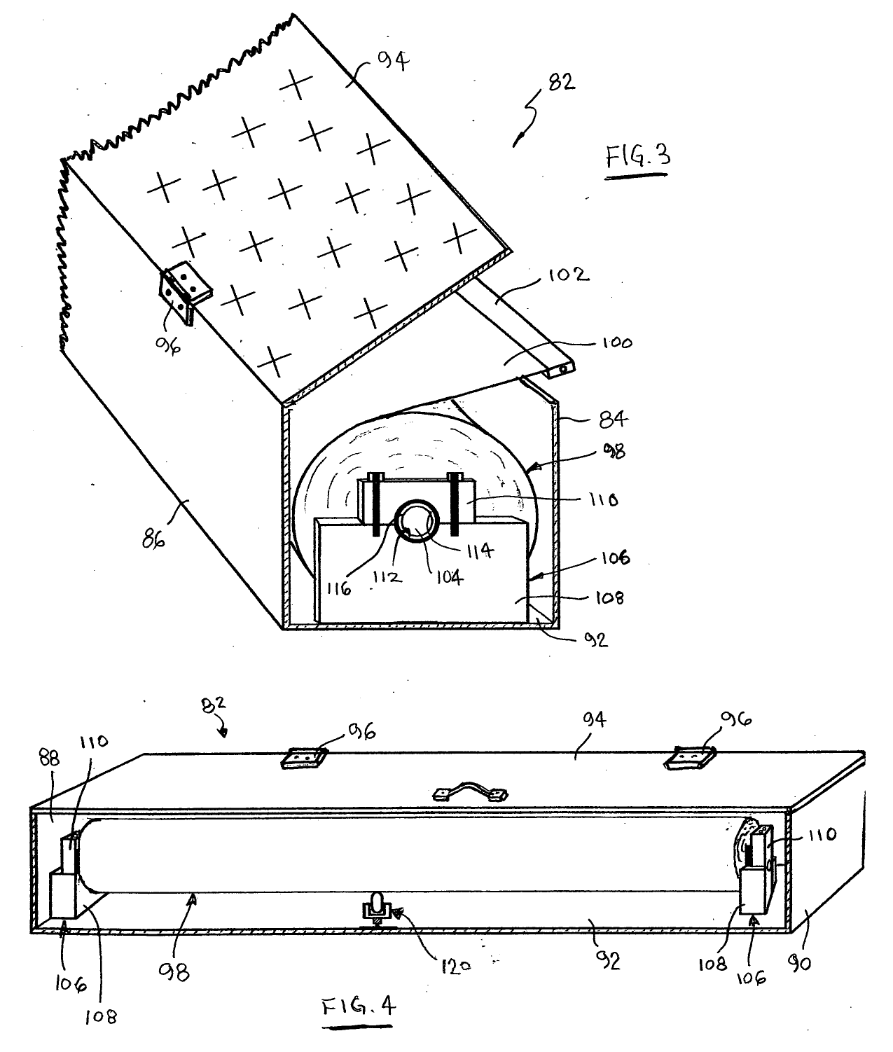

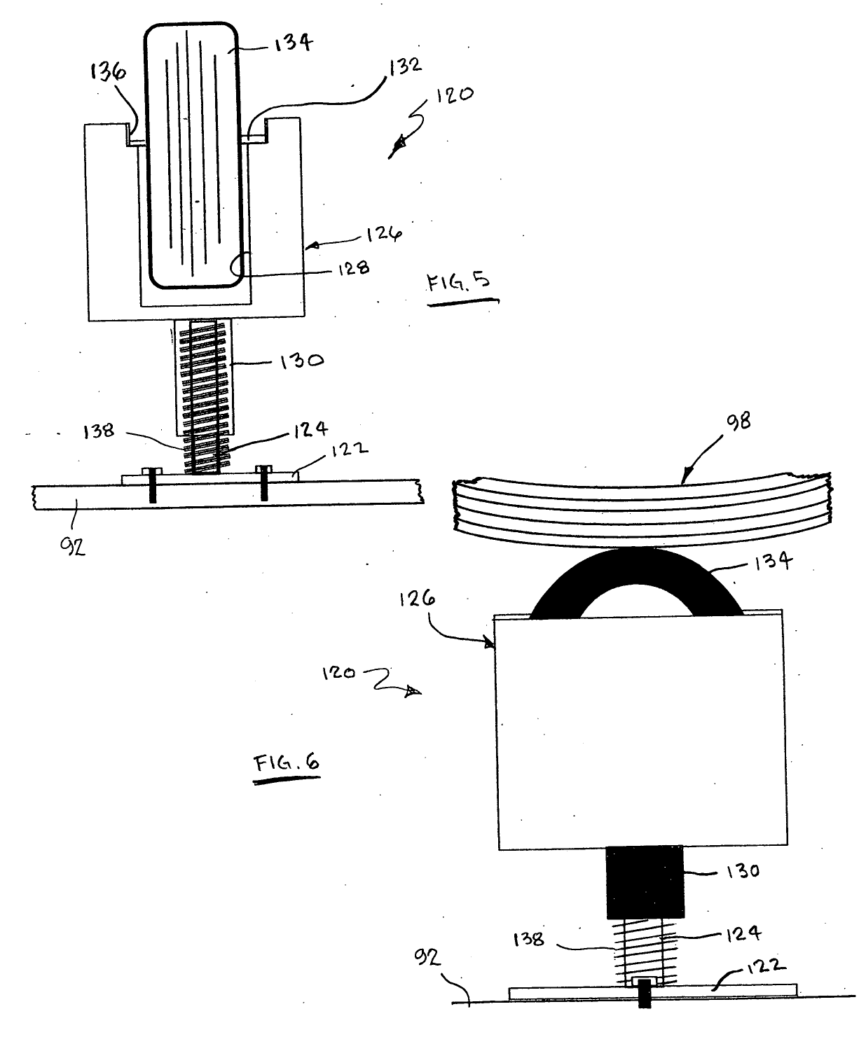

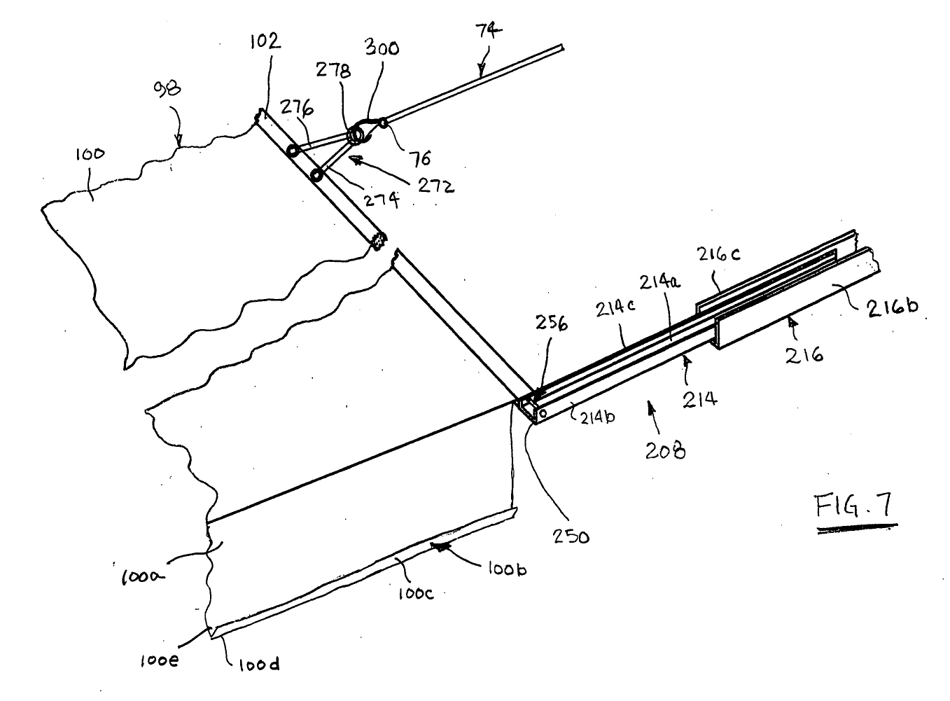

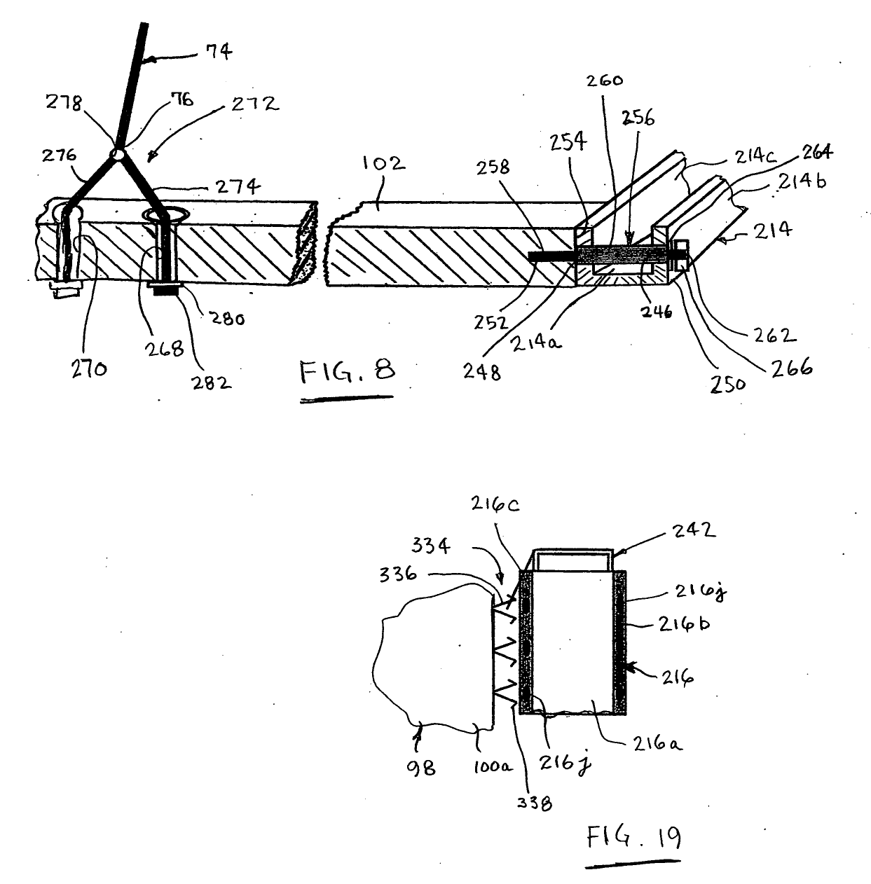

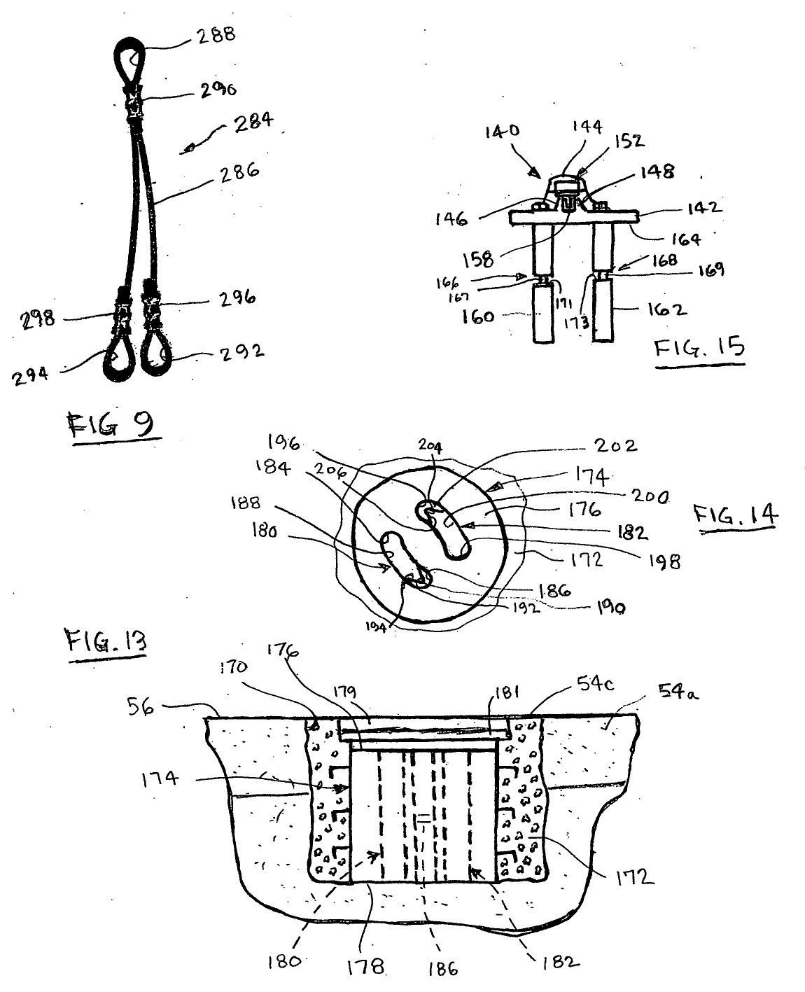

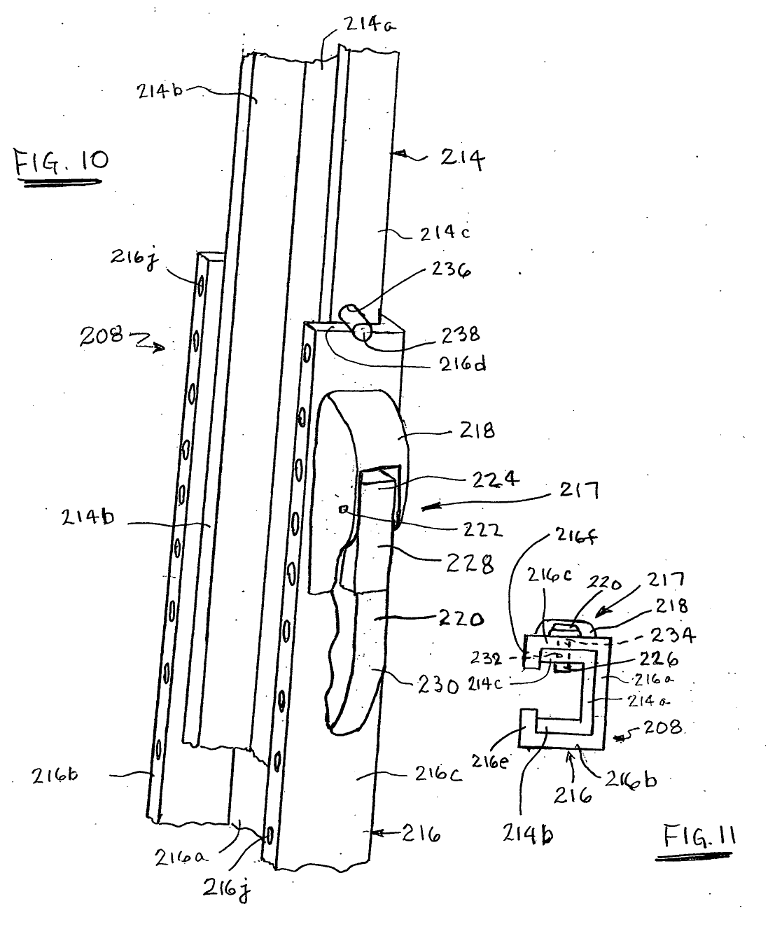

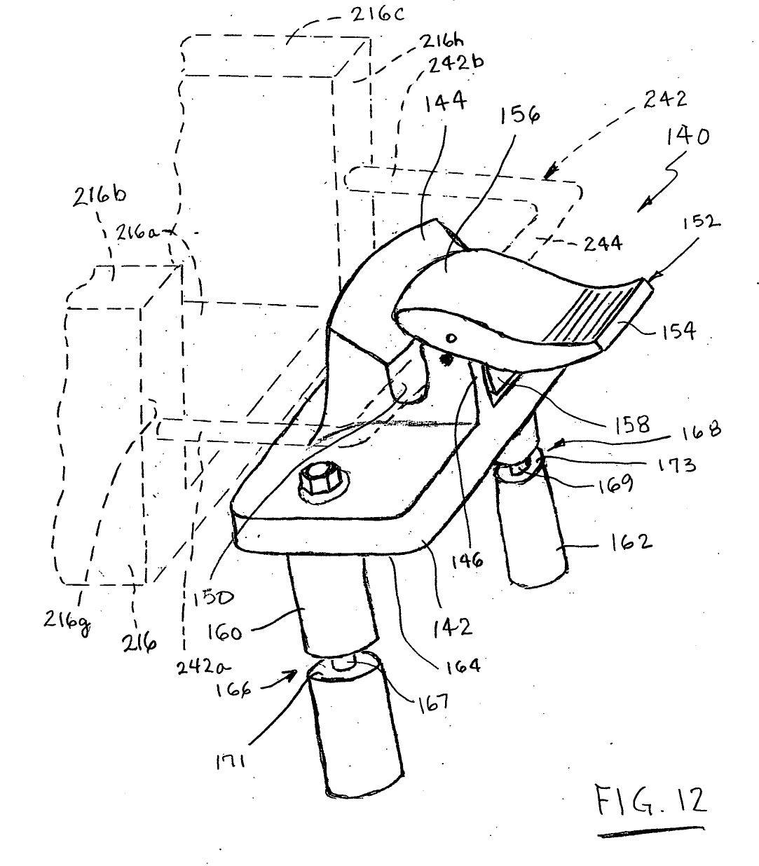

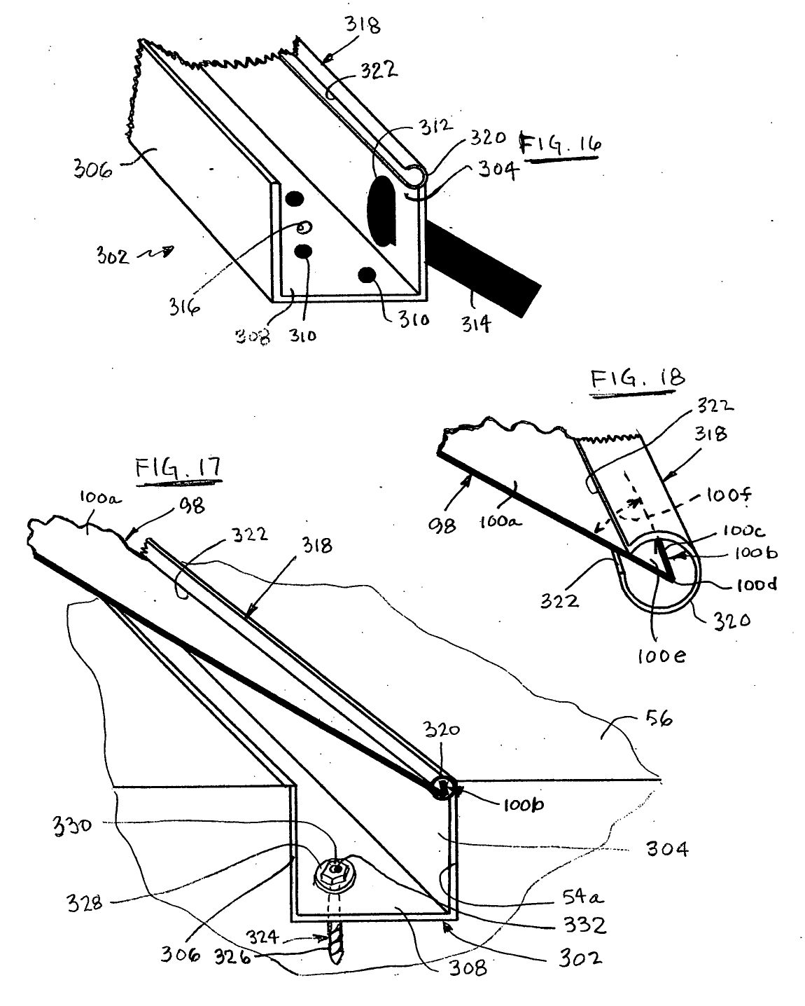

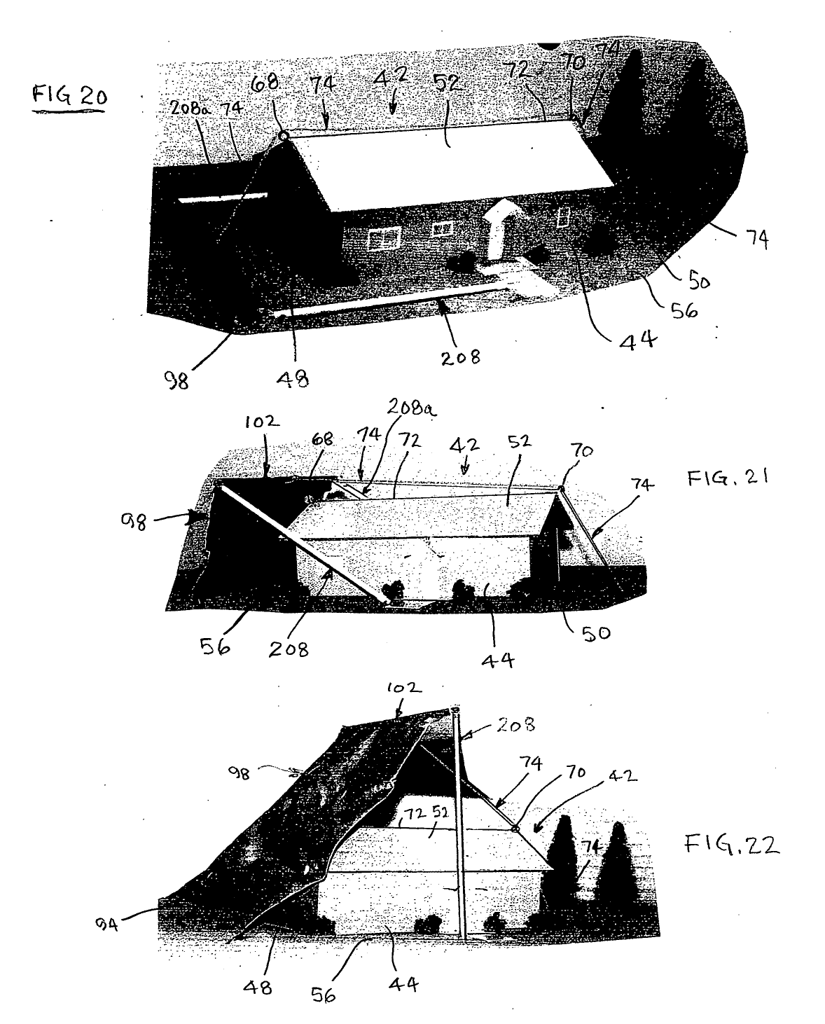

A weather protection system 40, as illustrated in FIGS. 2 and 20 through 24, provides a protective wind and rain shield for a structure 42, as illustrated in FIGS. 1, 2 and 20 through 24, in the presence of violent and destructive weather of the type which typically occurs during adverse weather conditions, such as, for example, hurricanes, tornados, cyclones, and the like. The structure 42 to be protected, as illustrated in FIGS. 1, 2 and 20 through 24, is a residential dwelling. However, the weather protection system 40 can be used to provide a protective shield for other types of structures, such as, for example, trailers, apartment buildings, office buildings, warehouse buildings, manufacturing buildings, and the like, without departing from the spirit and scope of the invention.

Referring further to FIGS. 1 and 2, the exterior of the structure 42 is formed with a front wall 44, a rear wall 46, a right side wall 48, a left side wall 50, and a roof 52. In preparation for placement of the various components of the weather protection system 40 adjacent the structure 42, a continuous trench 54 is formed in the ground 56, adjacent, spaced from, and about the structure.

It is noted that any of the front wall 44, the rear wall 46, the right side wall 48, and the left side wall 5, could be referred to as a first section of the structure 42, with the wall on the opposite side of the first section being referred to as the second section of the structure. For example, if the right side wall 48 is referred to as the first section of the structure 42, the left side wall 50 would be the second section of the structure.

A major or first portion 54a of the trench 54 is formed with a prescribed depth and a prescribed width. A second portion 54b of the trench 54, located adjacent, and spaced from, the right side wall 48 of the structure 42, is formed with a depth and width which is greater than the prescribed depth and prescribed width, respectively, of the first portion 54a of the trench. The second portion 54b of the trench 54 is formed with a length which extends, at opposite ends thereof, beyond opposite ends of the right side wall 48 of the structure 42, which are contiguous with the front wall 44 and the rear wall 46.

A third portion 54c, and a fourth portion 54d (FIG. 2), of the trench 54 are located adjacent, centered along, and spaced from, the front wall 44 and the rear wall 46, respectively, of the structure 42. The width and depth of each of the third portion 54c and the fourth portion 54d, of the trench 54, are greater than the prescribed depth and the prescribed width, respectively, of the first portion 54a of the trench. In addition, the length of each of the third portion 54c and the fourth portion 54d of the trench 54 is substantially the same as the width of the respective third and fourth portions.

A trench 58 of narrow width and depth is formed in the ground 56, and extends from a central section of the right side wall 48 of the structure 42 to, and is in communication with, a central section of the length of the second portion 54b of the trench 54. In similar fashion, a trench 60, having a width and depth which corresponds to the width and depth, respectively, of the trench 58, is formed in the ground 56, and extends from a central section of the left side wall 50 of the structure 42 to, and is in communication with, the first portion 54a of the trench 54 adjacent the left side wall.

A weather and moisture protective vault 62 (FIG. 2), with removable cover (not shown), is mounted in a well 63 formed in the ground 56. The well 63 is located adjacent an outer edge of the first portion 54a of the trench 54, which is adjacent and spaced from the center section of the left side wall 50 of the structure 42, with the well being aligned generally, and in communication, with the trench 60. As shown in FIG. 2, the vault 62 is sized sufficiently to receive a cable reel 64 and a drive motor 66, which is coupled drivingly to the cable reel. The drive motor 66 is connected, through an on/off switch (not shown), to an electrical power source to facilitate selective operation of the drive motor.

The cable reel 64 and the drive motor 66 are components of the weather protection system 40. The depth of the vault 62 is sufficiently sized so that the cover can be placed over the vault after the cable reel 64 and the drive motor 66 have been placed in the vault. Thereafter, sod can be placed over the well 63, and onto the cover of the vault 62, to provide an unobtrusive concealment for the protected location of the cable reel 64 and the drive motor 66, during periods when the weather protection system 40 is not being used.

As further shown in FIG. 2, the weather protection system 40 also includes a first guide pulley 68 and a second guide pulley 70. The first guide pulley 68 is attached, for free rotation, to a ridge 72 (FIG. 1), or high point, of the roof 52 of the structure 42, at an end of the ridge, which is located above, and is aligned with, the trench 58. The second guide pulley 70 is attached to the ridge 72 of the roof 52 of the structure 42, at an end of the ridge, which is located above, and is aligned with, the trench 60, and is spaced from the first guide pulley 68.

A cable 74, which is also a component of the weather protection system 40, has a first end 76 located within the trench 58 in an area of a junction of the trench 58 with the second portion 54b of the trench 54. The cable 74 continues through the trench 58 to the right side wall 48, upward along the center section of the right side wall, over the first guide pulley 68, above the ridge 72 of the roof 52, over the second guide pulley 70, downward along the center section of the left side wall 50, through the trench 60, with a second end 78 of the cable being attached to the cable reel 64. The trenches 58 and 60 could be covered in the same manner that the well 63 is covered to provide unobtrusive concealment of the portions of the cable 74, which are located within the trenches 58 and 60, during periods when the weather protective system 40 is not being deployed.

As shown in FIG. 1, a cable concealment sleeve 80 is attached to, and extends vertically over, the central section of the right side wall 48 of the structure 42. A portion of the cable 74 is threaded axially through the sleeve 80 from a lower end to an upper end thereof, and is concealed within the sleeve. The sleeve 80 is composed of a flexible material, which is capable of retaining its sleeve-like configuration, but allowing some flexing of the material. A longitudinal slit (not shown) is formed in the outward facing surface of the sleeve 80, and extends from the lower end to the upper end of the sleeve to allow the concealed portion of the cable 74 to be extracted from the sleeve, and through the slit.

Referring to FIG. 1, if the cable 74 is not stressed in a direction away from the right side wall 48 of the structure 42, the cable will remain within the sleeve 80 for an unobtrusive concealment thereof. When the cable 74 is stressed in a direction away from the right side wall 48 of the structure 42, the cable will exert a force against an inside wall of the sleeve 80, along the length of the slit. Reactively, the area of the sleeve 80 adjacent the slit is flexed, thereby allowing the cable 74 to be forced outward from within the sleeve.

A cable concealment sleeve (not shown), which is identical to the sleeve 80, is attached to, and extends vertically over, the central section of the left side wall 50 of the structure 42 in the same manner as the sleeve 80 is attached to the right side wall 48. The sleeve, which is attached to the left side wall 50, functions in the same manner as the sleeve 80, that is, to conceal a portion of the cable 74 unobtrusively when the cable is not stressed, and to allow the cable to exit through the slit of the sleeve when the cable is stressed.

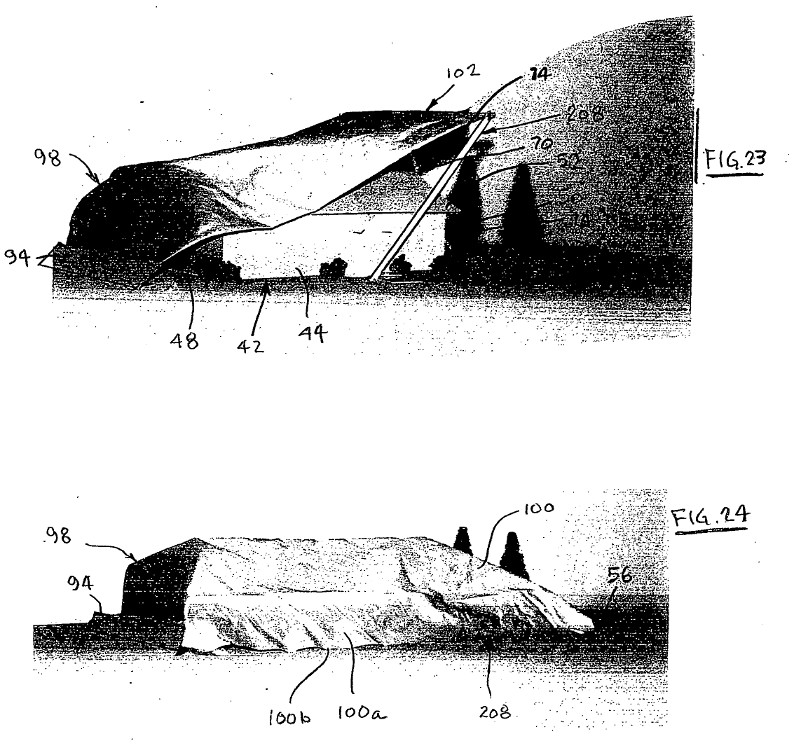

Referring to FIGS. 3 and 4, a vault or storage container 82 is formed with a front wall 84, a rear wall 86, a right side wall 88, a left side wall 90, a floor 92 and a lid 94, which is attached by hinges 96 to the rear wall. The parameters of the storage container 82 are such that a weather protective cover 98, in the form of a flexible sheet 100, can be stored in the container, in a reeled configuration, during periods when the weather protection system 40 is not in use. The storage container 82 is composed of a corrosive-resistant material, such as, for example, stainless steel, and is sealed when the lid 94 is closed to preclude the entry of damaging moisture. It is noted that, when the cover 98 is in the reeled configuration within the storage container, the cover is considered to be in a structure-uncovering position, that is, the cover is not covering the structure 42. When the cover 98 is placed onto the structure 42, as shown in FIG. 24, the cover is considered to be in a structure-covering position.

The cover 98 is composed of a high tensile, fabric-like material, which is woven in a pattern to be resistant to the forces of wind, and rain, of the type typically occurring during adverse weather conditions. Further, the cover 98 is sufficiently flexible to facilitate the folding and rolling of the sheet 100 into the reeled configuration, and the eventual unreeling and placement of the cover over and onto the structure 42, to form an enclosure about the structure.

As further shown in FIG. 3, a rigid bar 102 is attached to at least a portion of a leading edge of the cover 98, and the cover is pre-rolled onto a cover reel 104, the ends of which extend beyond the sides of the reeled cover. The at least a portion of the leading edge of the cover 98, which is attached to the rigid bar 102, is hereinafter referred to as the leading-edge portion of the cover.

Referring again to FIGS. 3 and 4, a pair of spaced mounting assemblies 106 are located within the storage container 82, adjacent respective ones of the right side wall 88 and the left side wall 90. Each of the mounting assemblies 106 includes a support block 108, mounted on, and secured to, the floor 92 of the container 82, and further includes a clamp block 110, which is mounted on, and secured to, the top of the support block.

The support block 108, of each of the mounting assemblies 106, is formed with a semi-circular groove 112, which interfaces with a semi-circular groove 114, formed in the respective clamp block 110 of each the mounting assemblies, to form a circular opening. A bushing 116 is located within the circular opening formed by the interfacing semi-circular grooves 112 and 114. Each of the opposite ends of the cover reel 104 is located within the respective bushing 116 for rotation therein. Each of the mounting assemblies 106 includes a pair of headed bolts 118 to secure the clamp block 110 with the support block 108.

During an unreeling process as described below, when the cover 98 is being unreeled from its reeled configuration as shown in FIGS. 3 and 4, the compression of each of the ends of the cover reel 104 within the respective bushing 116 is such that the reeled cover is allowed to rotate relatively easily within the respective bushing 116 to facilitate the unreeling process.

When the unreeling process ceases, there is a tendency for the cover 98 to reverse direction undesirably, but only for an instant. Even so, such reverse direction of movement of the unreeled portion of the cover 98, could result in the rigid bar 102 being slightly displaced from its intended location. However, each of the ends of the reel 104 are mounted within the respective bushing 116 with sufficient compression to preclude any undesirable reverse direction of movement of the unreeled portion of the cover.

Referring now to FIGS. 4, 5 and 6, a reel center support 120 includes a bottom plate 122 which is secured to a central section of the floor 92 of the container 82, with a post 124 being attached to, and extending upward from, the bottom plate. A U-shaped frame 126 is formed with a well 128, and a sleeve 130, with an open lower end, is attached at an upper end thereof to an underside of the frame. A shaft 132 extends through, and from opposite sides of, an axial center of a wheel 134, with opposite ends of the shaft resting in a nest 136 at a top of the frame 126. The wheel 134 is composed of non-rigid material such as, for example, rubber or the like. A compression spring 138 is positioned over the post 124, and the open lower end of the sleeve 130 is located over the assembled spring and post.

As shown in FIG. 6, a center portion of the reeled cover 98 is supported on the wheel 134, where the weight of the center portion urges the frame 126 downward toward the plate 122, which compresses the spring 138. As the cover 98 is withdrawn from the reel 104, as described below, the weight of the center portion of the cover, which remains on the reel, decreases. As the weight decreases, the compression spring 138 urges the wheel 134 upward, whereby the reel center support 120 continues to support the center portion of the reeled cover 98.

Referring to FIGS. 12 and 15, a pivot mount 140 includes a base 142 and a hub 144 formed integrally with, and extending upward from, a central portion of the base. Also, a pair of spaced pivot supports 146 and 148 are formed integrally with, and extend upward from, the central portion of the base 142. The spaced pivot supports 146 and 148 are spaced forward of the hub 144 to form a channel 150, with a top opening between the hub and the supports.

A channel-cover arm 152 is mounted on, and straddles, the spaced pivot supports 146 and 148 for pivotal movement relative thereto. The channel-cover arm 152 is formed with an actuating section 154, which extends from the pivot supports 146 and 148, in a direction away from the hub 144. The channel-cover arm 152 is also formed with a cover section 156 formed integrally with the actuating section 154, which extends from the supports 146 and 148 toward the hub 144, and over the channel 150.

The channel-cover arm 152 is formed with a tab 158, which extends from an underside of the arm, and which is located in a space between the pivot supports 146 and 148. A compression spring (not shown) is located within an opening of the pivot clamp 140, and is positioned to urge the tab 158 outward from the space between the pivot supports 146 and 148. As the compression spring urges the tab 158 outward, the channel-cover arm 152 is urged in a counterclockwise direction, as viewed in FIG. 12, whereby the cover section 156 is urged into engagement with the hub 144, and is located over, and covers, the top opening of the channel 150.

The top opening of the channel 150 can be cleared of any obstruction by the cover section 156, and thereby opened, by depressing the actuating section 154 to pivot the channel-cover arm 152 in a clockwise direction, as viewed in FIG. 12. When the actuating section 154 is released, the compression spring urges the tab 158 outward, whereby the cover section 156 returns to a locking position over the top opening of the channel 150.

Referring again to FIGS. 12 and 15, a pair of spaced locking rods 160 and 162, of circular cross section, are attached to, and extend axially from an underside 164 of, the base 142 of the pivot mount 140. Annular recesses 166 and 168 are formed in intermediate sections of the locking rods 160 and 162, respectively, with the recesses having the same axial length, and located by the same distance from the underside 164 of the base 142. As a result of forming the recesses 166 and 168, respective reduced sections 167 and 169 of the respective rods 160 and 162 are formed, as is respective shoulders 171 and 173.

Referring to FIG. 13, at the site of the third portion 54c (FIG. 2) of the trench 54, a hole 170 of prescribed dimensions is formed in the ground 56. Concrete 172, in a fluid state, is deposited into the hole 170, and a locking member 174 is placed in the fluid concrete. After the concrete 172 has cured, and is in a solid state, the locking member 174 is now secured within the hole 170, with a top surface 176 of the locking member being slightly below the outer level of the ground 56, and a bottom surface 178 of the locking member being at, or near, the bottom of the hole.

A stepped recess 179 is formed in the ground 56, above the top surface 176 of the locking member 174. A complementarily stepped cap 181 is inserted into the stepped recess 179, during periods when the weather protection system 40 is not in use, to prevent debris from entering a pair of passages 180 and 182 (FIG. 14) formed in the locking member 174, as described below.

Referring to FIGS. 13 and 14, the pair of spaced arcuate passages 180 and 182, formed in the locking member 174, extend between the top surface 176 of the locking member, at which the passages are open, and the bottom surface 178 of the locking member, at which the passages are closed.

As viewed in FIG. 14, the arcuate passage 180 is formed with spaced cylindrical sections 184 and 186, at opposite sides of the passage, which are linked by an arcuate section 188 of the passage. A shelf 190, having a thickness slightly less than the prescribed axial length of the annular recess 166 of the rod 160, is located within the cylindrical section 186, at a depth within the cylindrical section which is consistent with the ultimate location of the recess within the cylindrical section. The shelf 190 is formed with a central open nest 192 with a flared lead-in passage 194.

In similar fashion, the arcuate passage 182 is formed with spaced cylindrical sections 196 and 198, at opposite sides of the passage, which are linked by an arcuate section 200 of the passage. A shelf 202, having a thickness slightly less than the prescribed axial length of the annular recess 168 of the rod 162, is located within the cylindrical section 198, at a depth within the cylindrical section which is consistent with the ultimate location of the recess within the cylindrical section. The shelf 202 is formed with a central open nest 204 with a flared lead-in passage 206.

When the weather protection system 40 is to be used, the cap 181 is removed to expose the top surface 176 of the locking member 174. The pivot mount 140 is manipulated to insert the rods 160 and 162 axially into the cylindrical sections 184 and 198 of the passages 180 and 182, respectively, to a prescribed depth, at which the respective annular recesses 166 and 168, of the rods, are aligned within a plane which includes the respective shelves 190 and 202. The pivot mount 140 is then manipulated to laterally move the rods 160 and 162 through the respective arcuate passages 188 and 200.

Eventually, the reduced sections 167 and 169 of the rods 160 and 162, respectively, enter the lead-in passages 194 and 206, and then into the respective nests 192 and 204 of the shelves 190 and 202. The shelves 190 and 202 are now located above the shoulders 171 and 173, respectively, of the respective rods 160 and 162, to preclude upward movement of the rods and the pivot mount 140. In this manner, the pivot mount 140, and the rods 160 and 162 are locked to the locking member 174, which is fixedly mounted in the ground hole 170, as described above.

At the site of the fourth portion 54d (FIG. 2) of the trench 54, a locking member, identical to the locking member 174, is secured within a hole in the ground 56 in the same manner as described above with respect to securance of the locking member 174 within the hole 170 (FIG. 13). A pivot mount, identical to the pivot mount 140 (FIG. 15), is provided for assembly with, and locking to, the locking member at the fourth portion 54d of the trench 54 in the same manner that the pivot mount 140 is assembled with, and locked to, the locking member 174, as described above.

Referring again to FIG. 2, during periods when the weather protection system 40 is being assembled in preparation for adverse weather conditions, a first lift arm 208 extends from the third portion 54c of the trench 54 to a location adjacent a first end 210 of the trench portion 54b. Similarly, a second lift arm 208a extends from the fourth portion 54d of the trench 54 to a location adjacent a second end 212 of the trench portion 54b. It is noted that the first lift arm 208 and the second lift arm 208a combine to form a cover-following lifting mechanism.

The first lift arm 208 and the second lift arm 208a, which form a pair of lift arms, are identical in structure, and function in the same manner. Therefore, only the structure of the first lift arm 208, and the manner in which the first lift arm is assembled with other components of the weather protection system 40, will be described in detail below, it being understood that the second lift arm 208a is identical in structure, and method of assembly, to the first lift arm.

Referring to FIGS. 2, 7, 10, and 11, the lift arm 208 is formed by a first channel bar 214 and a second channel bar 216. The first channel bar 214 is smaller, in cross-section dimensions, than the second channel bar 216, with the first channel bar being slidable within a channel formed by the larger second channel bar, in a telescoping fashion.

The first channel bar 214 is formed with a longitudinal base 214a, and a pair of spaced longitudinal side walls 214b and 214c, which are integrally formed with respective longitudinal edges of the base. In similar fashion, the second channel bar 216 is formed with a longitudinal base 216a, and a pair of spaced longitudinal. side walls 216b and 216c, which are integrally formed with respective longitudinal edges of the base.

As shown in FIG. 10, a bar-lock assembly 217 includes a housing 218 fixedly attached to an outboard section of the side wall 216c of the second channel bar 216, in a portion thereof which overlaps with a portion of the first channel bar 214. A bar-unlock arm 220 is mounted on the housing 218 by a pivot pin 222, which extends through opposite sides of the housing and the bar-unlock arm, to facilitate pivoting movement of the bar-unlock arm relative to the housing. A compression spring (not shown) is located within the housing 218, and presses against an inboard spring-engagement face of a head portion 224 of the bar-unlock arm 220 above the pivot pin 222, thereby urging the bar-unlock arm in a clockwise direction about the pivot pin, as viewed in FIG. 10.

Referring to FIG. 11, a locking pin 226 is attached to, and extends outward from, an inboard locking-pin face of an intermediate portion 228 of the bar unlock arm 220, below the pivot pin 222. A tail portion 230 of the bar-unlock arm 220 provides facility for an assembler to move the bar-unlock arm in a counterclockwise pivoting motion against the biasing action of the compression spring, to thereby selectively move the locking pin 226.

An alignment hole 232 is formed through the side wall 214c of the first channel bar 214, and an alignment hole 234 is formed through the side wall 216c of the second channel bar 216, with the side walls of the first and second channel bars being in sliding engagement. The location of the alignment holes 232 and 234 has been predetermined, and formed, to insure that the holes are aligned when the first and second channel bars 214 and 216 have been extended to attain a desired, or operational, length of the lift arm 208 (FIG. 2).

As further shown in FIG. 11, a forward end of the locking pin 226 normally is urged into the alignment hole 234 of the second channel bar 216 by the compression spring. However, when the first and second channel bars 214 and 216, respectively, are being moved relatively to attain the desired length of the lift arm 208, the forward end of the locking pin 226 is prevented from moving through, and out of, the alignment hole 234 by the presence of the side wall 214c.

When the desired length of the lift arm 208 is attained, the alignment hole 232 of the first channel bar 214 is aligned with the alignment hole 234 of the second channel bar 216, and the compression spring urges the forward end of the locking pin into, and through, the alignment hole 232 to lock the first channel bar and the second channel bar 216 together. This arrangement precludes any relative sliding movement between the first channel bar 214 and the second channel bar 216 during operation of the weather protection system 40.

Referring to FIG. 10, as a safety back-up, a hole 236 may be formed through a section of the side wall 214c of the first channel bar 214. The hole 236 is located a prescribed distance from the alignment hole 232, and is immediately adjacent, and clear of, a forward end 216d of the second channel bar 216, when the lift arm 208 has been adjusted to the desired length. A safety-lock pin 238 is driven into the hole 236, with an intermediate portion of the pin being in engagement with the forward end 216d of the second channel bar 216. With this arrangement, the safety lock pin 238 assists the locking pin 226 to preclude the first channel bar 214 from sliding downward within the second channel bar 216 as the lift arm 208 is being pivoted, when the protective cover 98 is being pulled over, and onto, the structure 42.

When it is desired to move the first and second channel bars 214 and 216 to a shorter, or non-operational, storage length, the assembler removes the safety-lock pin 238 from within the hole 236. The assembler then grips the tail portion 230 of the bar-unlock arm 220, and pulls the tail portion away from the adjacent side wall 216c of the second channel bar 216, against the biasing action of the compression spring. This action results in withdrawal of the forward end of the locking pin 226 from within the alignment hole 232 of the first channel bar 214, thereby allowing the first channel bar to be slidably moved relative to, and within, the second channel bar 216. This allows the lift arm 208 to be adjusted to the storage length, which is less than the desired length, to facilitate storage of the lift arm in the storage container 82, when the lift arm is not in use.

Referring to FIG. 11, in an alternate embodiment, outboard edges of the side walls 216b and 216c of the second channel bar 216, which are opposite the edges thereof formed integrally with the base 216a, could be formed with inward-turned, interfacing, longitudinal ledges 216e and 216f. With this arrangement, the first channel bar 214 is allowed to slide relative to the second channel bar 216, in a longitudinal direction, but is precluded from moving outward from the base 216a by the presence of the ledges 216e and 216f.

Referring again to FIG. 12, the second channel bar 216 is formed with a trailing end, at which the side walls 216b and 216c are formed with end surfaces 216g and 216h, respectively. A pivot rod 242 is formed with a pair of spaced, parallel legs 242a and 242b, and a linking section 244, which is formed integrally, at opposite ends thereof, with a respective one of a first set of spaced ends of the pair of legs. A second set of spaced ends of the pair legs 242a and 242b are mounted and secured in the end surfaces 216g and 216h, respectively, of the second channel bar 216. In this manner, the pivot rod 242 extends outward from the trailing end of the second channel bar 216, where the linking section 244 of the rod can be positioned within the channel 150 of the pivot mount 140.

To facilitate the placement of the linking section 244 of the pivot rod 242 within the channel 150 of the pivot mount 140, the assembler depresses the actuating section 154 of the channel-cover arm 152, against the biasing action of the compression spring. This provides an open passage at the top of the channel 150 to facilitate the locating of the linking section 244 within the channel 150. Upon release of the actuating section 154, the compression spring urges the cover section 156 over, and closes, the top opening of the channel 150 to thereby retain the linking section 244 for rotation within the channel. In this manner, the lift arm 208 is allowed to pivot about the axis of the linking section 244, when the lift arm is being moved as the protective cover 98 is being placed over, and onto, the structure 42.

Referring to FIG. 8, aligned holes 246 and 248 are formed through the side walls 214b and 214c, near a forward end 250 (FIG. 7) of the first channel bar 214. Also, a threaded hole 252 is formed in an end 254 of the rigid bar 102.

As further shown in FIG. 8, a pivot member, or pivot bolt 256, is formed with a threaded forward end 258, a support section, such as an enlarged intermediate smooth shank 260, and a threaded trailing end 262. The diameter of the intermediate shank 260, or support section, is slightly less than the diameter of the aligned holes 246 and 248, which allows relative rotational movement between the bolt 256 and the lift arm 208.

It is noted that the threaded hole 252 of the rigid bar 102, the pivot bolt 256, the slip washer 264, the holes 246 and 248 in the lift arm 208, and the comparable structure for the lift arm 208a, form means for allowing movement of the cover-following lifting mechanism, that is, the lift arms, about the support section, that is, the shank 260, and relative to the rigid bar while the portion of the cover-following lifting mechanism is mounted on the support section.

After the first and second channel bars 214 and 216 have been adjusted from the storage length to the desired length of the respective lift arms 208 and 208a, and the channel bars are locked in place, as described above, the holes 246 and 248 of the first channel bar 214 are aligned with the threaded hole 252 of the rigid bar 102. The threaded forward end 258 of the bolt 256 is moved through the holes 246 and 248 of the first channel bar 214, and threadedly mounted into the threaded hole 252 of the rigid bar 102. At the same time, spaced portions of the intermediate shank 260 of the bolt 256 are located within the aligned holes 246 and 248, where the shank and the aligned holes are sized to allow the relative rotation as noted above. Thereafter, a slip spacer 264 is placed over the trailing threaded end 262 of the bolt 256, and a cap nut 266 is threadedly mounted onto the trailing threaded end of the bolt.

With the above-described arrangement, the first channel bar 214 is allowed to move about the axis of the bolt 256, relative to the rigid bar 102, without interference from any frictional engagement between outboard sections of the side walls 214b and 214c and the adjacent end 254 of the rigid bar 102 and the cap nut 266, respectively.

It is noted that, when the components of the weather protection system 40 are being formed, a single channel bar could be custom formed to the desired length, which is attainable with the adjusted first channel bar 214 and the second channel bar 216 as noted above, and serve the same cover-lifting function of the adjusted first and second channel bars, without departing from the spirit and scope of the invention.

It is also noted that the end 254 of the rigid bar 102 is considered a first section of the rigid bar, to which the forward end 250 of the first lift arm 208 is coupled. The end of the rigid bar 102, opposite the end 254, is considered a second section of the rigid bar, to which the forward end of the second lift arm 208a is coupled. Further, the first section and the second section of the rigid bar 102 could be inboard of the respective ends 254 of the rigid bar, with the forward end 250 of the first lift arm 208 and the second lift arm 208a being coupled to the inboard first and second sections, without departing from the spirit and scope of the invention.

As further shown in FIG. 8, a pair of spaced holes 268 and 270 are formed in an intermediate portion of the rigid bar 102 to facilitate the assembly of a coupling attachment 272 to the rigid bar. The coupling attachment 272 includes a pair of cable-like straps 274 and 276, each of which are attached, at one end thereof, to a ring 278. The opposite ends of the straps 274 and 276 are placed through the holes 268 and 270, respectively, and are secured to the rigid bar 102 by use of washers 280 and fasteners 282, with the fasteners being attached to the opposite ends of the straps.

Another example of a coupling attachment 284 is shown in FIG. 9, and includes a single piece of stranded cable 286. The cable 286 is formed with a closed loop 288 in an intermediate portion of the cable, and retained in the looped configuration by a crimped ferrule 290. The cable 286 is formed with closed loops 292 and 294 at respective opposite ends of the cable, and retained in the looped configuration by a pair of crimped ferrules 296 and 298, respectively.

In either of the above-described coupling attachments 272 or 284, the first end 76 of the cable 74 (FIG. 2) is attached to the ring 278 or the loop 288 of the cable 286, respectively. As shown in FIG. 7, at the time of making and assembling the various components for the weather protection system 40, the first end 76 of the cable 74 could be attached to a clip 300, which may be readily opened and closed by the assembler. When the cable 74 is to be coupled to the ring 278, or the cable loop 288 (FIG. 15), the clip 300 is manipulated to facilitate easy coupling of the cable to the rigid bar 102, in preparation for pulling the protective cover 98 over, and onto, the structure 42.

It is noted that, since the rigid bar 102 is attached to the leading-edge portion of the cover 98, and since the rigid bar facilitates attachment of the first end 76 of the cable 74 to the cover, the rigid bar is considered as an attachment portion of the cover.

As shown in FIG. 16, a drainage trough 302 is formed with an longitudinal outboard side wall 304 and a longitudinal inboard side wall 306, which are spaced apart and are integrally joined with a longitudinal base 308 at a lower edge of each of the side walls. A plurality of “weep” holes 310 are formed through, and at spaced locations along, the base 308 of the trough 302. A plurality of drainage ports 312 (one shown) are formed through, and at spaced locations along, the outboard side wall 304 of the trough 302. Each of a plurality of open-ended, laterally-enclosed drainage chutes 314 are buried in the ground 56, and are attached to the outboard side wall 304 of the trough 302 in communication, at one open end thereof, with a respective one of the plurality of drainage ports 312. Each of the plurality of drainage chutes 314 are angled away from the structure 42, and downward into the ground 56.

With this arrangement, water, which collects in the trough 302 and rises at least to a lower portion of the plurality of drainage ports 312, will flow outward from the trough, through the ports and the respective ones of the plurality of drainage chutes 314, and away and downward from the trough and the structure 42.

Also, a plurality of spaced mounting holes 316 (one shown) are formed through the base 308 of the trough 302.

An anchor sleeve 318 is formed integrally with, and extends longitudinally and continuously along, the upper edge of the outboard side wall 304. The anchor sleeve 318 is formed with a generally circular cross section 320, and is further formed with a longitudinal slit 322, which faces inward, generally toward the spaced side wall 306, and the structure 42. It is noted that the anchor sleeve 318, with the longitudinal slit 322, forms a lip receptor, which is integral with the drainage trough 302.

Referring to FIG. 17, sections of the trough 302 are placed snugly into the first portion 54a (FIG. 2) of the trench 54, formed in the ground 56, such that the base 308 of the trough sets on the bottom of the first portion of the trench, and with the slit 322 of the anchor sleeve 320 facing the structure 42. A leading end of a respective one of a plurality of fasteners 324, formed with cork-screw threads 326, is placed through each of the mounting holes 316, formed through the base 308 of the trough 302. The fastener 324 is then threadedly driven into the ground 56 for a distance, at which a prescribed degree of tactile resistance is encountered to continued driving of the fastener into the ground.

An upper portion of the fastener 324 is then broken away, leaving a small portion of the fastener protruding upward from the base 308 of the trough 302. A washer 328 is placed over the protruding small portion of the fastener 324 and onto the base 308, and a nut 330 is threadedly attached to the remainder of the protruding small portion of the fastener, and against the washer 328. A tack-weld bead 332 may be deposited onto the upper end of the small portion of the fastener 324 and an adjacent upper portion of the nut 330 to secure the nut to the fastener. With the plurality of fasteners 324 assembled in this manner, the trough 302 is firmly secured within the first portion 54a of the trench 54.

After securing the trough 302 within the trench 54a of the trench 54, the trough can be filled up to, but not at or above, the slit 322 of the sleeve 318, with a mixture of stiromite and top soil, preferably in a fifty percent ratio, to reduce the weight and increase the normal drainage.

As further viewed in FIG. 7, the outboard side edge of each of the opposite side panels 100a (one shown), on opposite side edges of the cover 98, is formed with a bendable, biased locking lip 100b, which extends longitudinally and continuously, for example, along at least a portion of each of the side edges of the cover, but preferably extends continuously from the leading end to the trailing end of each of the side edges of the cover.

The locking lip 100b is formed by a strip 100c, which is integrally formed along an inboard edge 100d of the strip with, and extends longitudinally along, a contiguous portion of the cover 98. The strip 100c is folded laterally along the inboard edge 100d, and over an adjacent surface 100e of the contiguous portion of the cover 98, and assumes a normal position, as illustrated in FIGS. 17 and 18. In the normal position, the strip 110c is angularly displaced from the adjacent surface 100e of the contiguous portion of the cover by a prescribed locking angle 100f (FIG. 18).

The strip 100c is bendable to the extent that, when an outside force is applied to urge the strip toward the adjacent surface 100e of the cover 98, the strip is moved, against a biasing property of the strip, into juxtaposition with the adjacent surface of the contiguous portion of the cover. When the outside force is removed, the biasing property of the strip 100c facilitates the return of the strip to the normal position.

When the weather protection system 40 is to be installed in the vicinity of the structure 42 for eventual use to protect the structure from adverse weather conditions, the locations for the portions 54a, 54b, 54c and 54d of the trench 54, the trenches 58 and 60, and the well 63 are determined, and are formed in the ground 56. Sections of the trough 302 are formed, placed, and secured, in the first portion 54a of the trench 54, as described above.

The storage container 82 is installed in the second portion 54b of the trench 54, and respective ones of the locking members 174 are installed within the third portion 54c, and the fourth portion 54d, of the trench, as described above. In addition, the vault 62 is placed in the well 63, the cable reel 64 and the drive motor 66 are then mounted within the vault 62, and the drive motor is connected, through the on/off switch, to the electrical power source.

The protective cover 98 is wound onto the cover reel 104, the rigid bar 102 is attached to the leading edge portion of the cover, and the coupling attachment 272 is assembled with the rigid bar.

As noted above, the cover 98 may include side panels 100a (FIG. 7) along opposite sides thereof (one edge shown). The leading portions of the side panels 100a are not attached to the rigid bar 102. Prior to the winding of the cover 98 onto the reel 104, the side panels 100a are folded inward of the cover and under the laterally adjacent portions of the cover 98, which are attached to, and trail, the rigid bar 102.

As the cover 98 is being wound onto the reel 104, the portion of the cover which trails the rigid bar 102, and the side panels 100a folded thereunder, are wound onto the reel in such a manner that the side-to-side length of the reeled cover, including the side panels, would be no longer than the end-to-end length of the rigid bar 102. Thus, when the cover 98 includes the folded side panels 100a, the rigid bar 102 is attached to the above-noted leading edge portion of the cover only, with remaining portions of the leading edge of the cover, which are the leading edges of the side panels 100a, not being attached to the rigid bar, or to any other facility.

The reeled cover 98, with the attached rigid bar 102 and the coupling attachment 272, are placed in the storage container 82, with the opposite ends of the reel 104 being secured in the mounting assemblies 106 at opposite ends of the storage container, in the manner described above. In addition, two of the pivot mounts 140, which are for ultimate assembly with the respective locking members 174 in the third and fourth portions 54c and 54d of the trench 54, are stored in the storage container 82. Further, the first and second channel bars 214 and 216, respectively, of each of the lift arms 208 and 208a, are slidably adjusted to place the lift arms in their storage length, whereafter both lift arms are stored in the storage container 82. Thereafter, the lid 94 of the storage container 82 is closed.

It is noted that no portion of the cable 74 engages any portion of the cover 98, nor is any portion of the cable 74 wound with the cover onto the cover reel 102. Consequently, there are no uneven bulges in the reeled cover 98.

The first end 76 of the cable 74 placed in the trench 58, adjacent the portion 54b of the trench 54. The remainder of the cable 74 is placed in the trench 58, in the cable concealment sleeve 80, over the pulley 68, over and above the ridge 72 of the roof 52 of the structure 42, over the pulley 70, in the cable concealment sleeve which is mounted on the left side wall 50 of the structure, in the trench 60, and into the vault 62, where the second end 78 of the cable is attached to the cable reel 64. The cover of the vault 62 is then placed over the vault.

The various portions 54a, 54b, 54c and 54d of the trench 54, the trenches 58 and 60, and the well 63 are covered with sod to provide an unobtrusive appearance adjacent the structure 42, when the weather protection system 40 is not being deployed.

While a particular order of the steps for preparing and storing the various components of the weather protection system 40 about the structure 42 has been described above, any other logical order of steps of preparation may be followed.

In the event adverse weather conditions are approaching the structure 42, the weather protection system 40 can be deployed to protect and shield the structure from wind and rain during such adverse conditions. Referring again to FIG. 1, initially, the sod, which is covering the well 63, the trenches 58 and 60, and the first, second, third, and fourth portions 54a, 54b, 54c, and 54d, respectively, of the trench 54, is removed. Thereafter, the cover for the vault 62 is removed, and the lid 94 for the storage container 82 is opened. The two pivot mounts 140 are removed from the storage container 82, and are assembled, and locked, in the respective locking members 174, located within the trench portions 54c and 54d of the trench 54, as described above.

The two lift arms 208 and 208a, which had been assembled and stored in their storage length, are removed from the storage container 82, and the first and second channel bars 214 and 216 of each of the lift arms are adjusted, relative to each other, and extended from the storage length to attain the desired length of the respective lift arm, as described above. As each of the lift arms 208 and 208a attains the desired length, the forward end of the locking pin 226 of the bar-lock assembly 217 is free to move into the aligned hole 232 of the first channel bar 214 to lock the first and second channel bars 214 and 216 together to retain the desired length. The safety-lock pin 238 is then inserted into the hole 236 formed in the side wall 214c, so that a side portion of the pin rests on the forward surface 216d of the second channel bar 216, as described above.

The channel-cover arm 152 of each of the pivot mounts 140 is pivoted to open the respective channel 150 thereof. The linking section 244 of each of the pivot rods 242, at the trailing end of the respective lift arms 208 and 208a, is placed into the open channel 150 of the respective pivot mount 140, whereafter the channel-cover arm 152 of each of the pivot mounts 140 is released to cover, and close, the respective channel. With this arrangement, the linking sections 244 of each of the pivot rods 242 is retained within the respective channel 150, to facilitate eventual pivoting movement of the lift arms 208 and 208a.

Thereafter, the forward end of each of the first channel bars 214, of the lift arms 208 and 208a, is attached to respective opposite ends of the rigid bar 102, as described above, to allow the lift arms 208 and 208a to be raised when the cover 98 is being pulled from the storage container 82, and over, and above, the structure 42. At this time, the lift arms 208 and 208a are located on the ground 56, in an initial position awaiting operation of the drive motor 66.

The clip 300, which is attached to the first end 76 of the cable 74, is attached to the ring 278 of the coupling attachment 272. As shown in FIG. 20, when the drive motor 66 is operated to initiate the cable-reeling process of taking up the cable 74 onto the cable reel 64, the lift arms 208 and 208a are pivoted slightly upward, and a tension is placed on the cable 74. As this occurs, portions of the cable 74 are urged from within the sleeve 80, and the sleeve on the left side wall 50 of the structure 40, and through the slits of the sleeves. The tensioned cable 74 then extends directly from the rigid bar 102 to the pulley 68, over the ridge 72 of the structure 42, over the pulley 70, and directly onto the cable reel 64.

Referring to FIG. 21, as the drive motor 66 continues to operate, the rigid bar 102 and the leading portion or section of the weather protective cover 98, as well as the portions which trail the leading portions, are pulled out of, and from the structure-uncovering position in, the storage container 82, and begin to be moved toward the structure-covering position onto the structure. Since the forward ends of the first channel bars 214 of the lift arms 208 and 208a are attached to the ends 254 of the rigid bar 102, the lift arms follow, in unison, the moving rigid bar and the cover 98. Thus, the lift arms 208 and 208a are not power-operated independently of the rigid bar 102, but are pivoted by virtue of the attachment of the lift arms to the rigid bar, and by the single drive motor 66 of the weather protection system 40 facilitating the winding of the cable 74 onto the cable reel 64. Therefore, as noted above, the lift arms 208 and 208a form a cover-following lifting mechanism, that is, the lifting mechanism follows the movement of the cover 98.

It is noted that the cable reel 64, the drive motor 66, and the cable 74 form a means located at least partially adjacent a second section, the left side wall 50, of the structure 42 spaced from the first section, the right side wall 48, thereof, with at least a portion of the structure being between the first section and the second section, and connectible to the attachment portion, the rigid bar 102, of the weather protective cover 98, for pulling the attachment portion, and thereby the weather protective cover, to a structure-covering position whereby the weather protective cover is over the at least a portion of the structure.

It is further noted that the cable reel 64, the drive motor 66, and the cable 74 also form means for moving the weather protective cover 98 from the structure-uncovering position to the structure-covering position onto the structure.

As the rigid bar 102 ascends to the height illustrated in FIG. 21, by virtue of the attachment to, and the in-unison action of, the lift arms 208 and 208a, the portion of the cable 74, which initially extended between the pulley 68 and the first end 76 of the cable, is now moved above, and out of engagement with, the pulley. Other portions of the cable 74 continue to be located over the ridge 72 of the structure 42, over, and in engagement with, the pulley 70, and directly onto the cable reel 64.

Referring to FIG. 22, the lift arms 208 and 208a have been pivoted to a nearly vertical position, as a result of the rigid bar 102 having been pulled over the roof 52 of the structure 42 by the power-driven cable reel 64 and the cable 74 attached thereto. In addition, leading portions of the cover 98 follow the rigid bar 102, whereby the leading portions are pulled over the roof 52 of the structure 42. Portions of the cable 74 continue to be in engagement with the pulley 70, to continue guiding the cable onto the cable reel 64.

Referring to FIG. 23, in similar fashion, the lift arms 208 and 208a have been pivoted to a position where the rigid bar 102 is generally above the left side wall 50 of the structure 42, and the cover 98 is essentially over the entire roof 52 of the structure 42.

It is noted that, while not shown in FIGS. 22 and 23, the folded-under side panels 100a of the cover 98 have begun to drop in the manner illustrated in FIG. 7.

Eventually, as shown in FIG. 24, essentially all of the cable 74 has been reeled onto the cable reel 64, and the protective cover 98 has been placed over, and onto, the structure 42. At this time, the operation of the drive motor 66 is stopped, and the lift arms 208 and 208a have been pivoted one hundred and eighty degrees from the initial position thereof, which is shown in FIG. 1, and rest on the ground 56 at a final position.

It is noted that the stopping of the motor 66 could be effected by the manual closing of the on/off switch by an operator who observes completion of the reeling operation, or could be effected automatically by a switching device, which senses that the cable reeling operation has been completed.

It is further noted that the cover 98 did not contact any portion of the rollers 68 and 70, the cable 74, or the lift arms 214 and 216 at any time during the deployment of the cover. Thus, the cover 98 was not subjected, during deployment thereof, to any potential wear and/or damage which could result from physical contact with other components of the weather protection system 40.

Therefore, the lift arms 208 and 208a form means, connectible to the attachment portion of the weather protective cover 98, and responsive to the pulling of the attachment portion from the structure-uncovering to the structure-covering, for spatially lifting the weather protective cover over the at least a portion of the structure 42.

Upon completion of the placement of the cover 98 onto the structure 42, the longitudinally continuous locking lip 100b of each of the side panels 100a is located in the vicinity of the trough 302, as shown in FIGS. 17 and 18. The assembler urges, or pinches, the locking lip 100b toward, and into juxtaposition with, the contiguous portion of the panel 100a. The locking lip 100b and the contiguous portion of the side panel 100a are held in juxtaposition as the lip and the contiguous portion are slipped longitudinally into the longitudinal slit 322.

As the urged locking lip 100b and the contiguous portion of the panel 100a begin to laterally enter through the slit 322, the lip and the contiguous portion are released by the assembler, but remain in juxtaposition by being captured between spaced side walls of the slit. As the locking lip 100b fully enters the sleeve 318, and clears the slit 322, the lip is moved away from the contiguous portion of the side panel 100a, under the normal biasing property of the lip, whereby the lip assumes the angular displacement with the contiguous portion by the locking angle 100f (FIG. 18). The locking lip 100b is now locked within, and longitudinally and continuously along the continuous length of, the sleeve 318, whereby the longitudinal and continuous edges of the cover 98 are secured at all points. With this arrangement, there are no spaces between any portions of the continuous secured edges of the cover 98, and no openings between the secured edges and the ground 56. Effectively then, the locking lips 100b and the sleeve 318 provide a securance facility which will resist any effort to pull the contiguous portion of the side panel 100a and the locking lip from locked assembly with the sleeve. In this manner, the protective cover 98 is secured in the deployed position about the structure 42.

When the protective cover 98 is placed onto the structure 42, as described above, an angular lay of side portions of the cover is formed between the lower border, or eaves, of the roof 52 and the locking lips 100b secured within the anchor sleeve 318. The side portions of the cover 98, which are formed with the angular lay, include the side panels 100a, and contiguous portions of the sheet 100, extending away and downward from the eaves of the roof 52 of the structure 42 to the secured locking lips 100b.

The angular lay of the above-noted side portions of the cover 98 is established by parameters such as the vertical distance from the ground 56 to the eaves of the roof 52, and the ground distance, at the level of the ground 56, between the structure 42 and the outboard side wall of the portion 54a of the trench 54. With the vertical distance from the ground 56 to the eaves of the roof 52 usually being fixed, the angular lay is basically determined by the selection of the ground distance of the outboard side wall of the portion 54a of the trench 54 from the structure 42. By use of these parameters, an effective angular lay of the side portions of the cover 98 can be calculated and constructed to provide a wind path which directs destructive winds away from the structure 42.

The above-described advantages of the angular lay of the side portions of the cover 98 are further enhanced by the continuous securance of the edges of the cover by the locking lips 100b and the sleeve 318, as described above. This arrangement effectively provides a continuous longitudinal buffer, or seal, along the edges of the side portions of the cover 98, which assists in efforts to preclude wind and rain from entering the enclosure formed by the cover over, and on, the structure 42.

As noted above, the composition and the weave of the cover 98 are designed to protect the structure 42 from the effects of wind and wind-driven rain, of the type which typically occurs during the adverse weather conditions noted above. Further, the location of the trough 302 is spaced considerably from the structure 42, and is designed, by formation of the “weep” holes 310 to collect any minor or low levels of water, which may tend to approach the structure 42, and drain such water, by seepage directly into the ground 56. The direction of the drainage through the “weep” holes 310 precludes the water from approaching the structure 42.

In some instances, during adverse weather conditions, water may approach the structure 42, at the level of the ground 56, and from a location which is outboard of the trough 302, whereby the water reaches, and flows into, the trough before any of the water reaches the structure. In such instances, the water is collected within the trough 302, with lower levels of the water in the trough being drained through the “weep” holes directly into the ground 56, as noted above, and any higher levels of the water in the trough are directed downward and away from the structure 42 through the arrangement of the drainage ports 312 in the side wall 304 of the trough, and through the drainage chutes 314.

Referring to FIG. 19, in an alternate technique for securing the outboard edges of the side panels 100a, each of a plurality of spring clips 334 is formed with a pair of angularly spaced, biased legs 336, which are integrally joined at an apex of the angular spacing thereof. Each of the legs 336 of each clip 334 is formed with a foot 338 extending at an acute angle from an outboard end of the respective leg, and in a direction away from the opposite leg of the clip. The legs 336 are connected at their apex to the outboard edge of the side panel 100a, at spaced locations along the edge.

A plurality of spaced, elongated holes 216j are formed in the upper edges of the side walls 216b and 216c of the second channel bar 216. Normally, the outboard ends of the legs 336, of each of the spring clips 334, are biased apart by a distance which precludes entry of the outboard ends into any of the plurality of holes 216j of the second channel bar 216.

When the protective cover 98 is placed over, and onto, the structure 42, each of the spring clips 334 is located adjacent a related one of the plurality of holes 216j formed in the second channel bar 216. The assembler urges, or pinches, the legs 336 of each clip 334, against the biasing force of the legs, to move the legs toward each other, sufficiently so that the outboard ends of the legs of each clip, and the foot 338 of each leg, are insertable into a respective one of the plurality of holes 216j. After inserting the pinched pair of legs 336, and the foot 338 of each leg, into a respective one of the plurality of holes 216j, the assembler releases the pinched legs 334, whereby, under the biasing force of the clip 334, the legs return to the spread-apart normal position. With this arrangement, the outboard ends of the legs 336 of each clip 334, and each foot 338 formed therewith, are captured within the respective hole 216j of the second channel bar 216, to facilitate securance of the edges of the side panels 100a with the bar.

It is noted that holes, such as the plurality of holes 216j, could be formed in rails (not shown), which are mounted in the ground 56 in place of, or in addition to, the trough 302. Further, the anchor sleeve 318 of the trough 302 could be replaced with a flat ledge, which extends along the upper edge of the side wall 304 of the trough, and the ledge is formed with spaced holes to receive the spring clips 334 for securance of the side panels 100a in the manner described above.

In general, the above-identified embodiments are not to be construed as limiting the breadth of the present invention. Modifications, and other alternative constructions, will be apparent which are within the spirit and scope of the invention as defined in the appended claims.

What is claimed is:

1. A weather protection system for use with a structure to be shielded from adverse weather conditions, which comprises:
a weather protective cover having an attachment portion locatable adjacent a first section of the structure when the weather protective cover is in a structure-uncovering position;
means located at least partially adjacent a second section of the structure spaced from the first section thereof, with at least a portion of the structure being between the first section and the second section, and connectible to the attachment portion of the weather protective cover, for pulling the attachment portion, and thereby the weather protective cover, to a structure-covering position whereby the weather protective cover is over the at least a portion of the structure; and
means, connectible to the attachment portion of the weather protective cover, and responsive to the pulling of the attachment portion from the structure-uncovering position to the structure-covering position, for spatially lifting the weather protective cover over the at least a portion of the structure.

2. The weather protection system as set forth in claim 1, wherein the attachment portion is a rigid bar attached to at least a portion of a leading edge of the weather protective cover.

3. The weather protection system as set forth in claim 1, wherein the means for pulling the attachment portion comprises:
a cable reel;
a drive motor which is coupled drivingly to the cable reel; and
a cable having a first end attachable to the attachment portion of the weather protective cover, and a second end attachable to the cable reel.

4. The weather protection system as set forth in claim 1, wherein the means for spatially lifting the weather protective cover comprises:
a first lift arm having a forward end and a trailing end;
the forward end of the first lift arm being attachable to a first section of the attachment portion;
the trailing end of the first lift arm being mountable to facilitate pivoting movement of the first lift arm;
a second lift arm spaced from the first lift arm, and having a forward end and a trailing end,
the forward end of the second lift arm being attachable to a second section of the attachment portion, spaced from the first section thereof; and
the trailing end of the second lift arm being mountable to facilitate pivoting movement of the second lift arm.

5. The weather protection system as set forth in claim 4, wherein the trailing ends of the first lift arm and the second lift arm are locatable intermediate the first section of the structure and the second section of the structure, and on opposite respective sides of the portions of the structure which extend between the first and second sections thereof.

6. The weather protection as set forth in claim 4 wherein each of the first lift arm and the second lift arm comprises:
a first channel bar,
a second channel bar mounted in engagement with, and for sliding movement relative to, the first channel bar; and
a bar-lock assembly for locking the first channel bar with the second channel bar, to preclude sliding movement therebetween.

7. The weather protection system as set forth in claim 4, which further comprises:
a rigid bar, which forms the attachment portion, attached to at least a portion of a leading edge of the weather protective cover; and
the forward ends of each of the first lift arm and the second lift arm being coupled to the rigid bar to allow relative movement of the forward ends relative to the rigid bar, while maintaining the coupling between the forward ends and the rigid bar.

8. The weather protection system as set forth in claim 5, which further comprises:
a first locking member fixedly mounted at a location adjacent the structure where the trailing end of the first lift arm is locatable;
a first pivot mount removably assembled with the first locking member;
the trailing end of the first lift arm being attachable to the first pivot mount;
a second locking member fixedly mounted at a location adjacent the structure where the trailing end of the second lift arm is locatable;
a second pivot mount removably assembled with the second locking member; and
the trailing end of the second lift arm being attachable to the second pivot mount.

9. The weather protection system as set forth in claim 1, which further comprises:
a lip receptor mounted fixedly adjacent and spaced from the portion of the structure between the first and second sections thereof;
a locking lip formed continuously along at least a portion of a side edge of the weather protective cover; and
the locking lip being locatable within the lip receptor to removably retain the at least a portion of the side edge with the fixedly mounted lip receptor.

10. The weather protection system as set forth in claim 9, wherein the lip receptor comprises:
a longitudinal sleeve; and
a longitudinal slit formed in the sleeve, through which the locking lip of the weather protective cover is inserted to removably retain the side edge of the weather protective cover with the fixedly mounted lip receptor.

11. The weather protection system as set forth in claim 8, wherein the locking lip comprises:
a strip integrally formed along an inboard edge thereof with, and extending longitudinally along, a contiguous portion of the weather protective cover;
the strip being folded laterally along the inboard edge and over an adjacent surface of the contiguous portion of the weather protective cover;
the strip assuming a normal position, where the strip is angularly displaced from the adjacent surface of the contiguous portion of the weather protective cover by a prescribed locking angle; and
the strip being bendable from the normal position toward the adjacent surface of the contiguous portion of the weather protective cover upon application of an outside force, and biased to return to the normal position when the outside force is removed.

12. The weather protection system as set forth in claim 1, which further comprises:
a drainage trough located adjacent, and spaced from, the at least a portion of the structure between the first section and the second section of the structure.

13. The weather protection system as set forth in claim 9, which further comprises:
a drainage trough located adjacent, and spaced from, the at least a portion of the structure between the first section and the second section of the structure, and
the lip receptor being integral with the drainage trough.

14. A weather protection system for use with a structure, having a prescribed height, to shield the structure from adverse weather conditions, which comprises:
a weather protective cover maintained in a structure-uncovering position prior to being positioned in a structure-covering position onto the structure;
means for moving the weather protective cover from the structure-uncovering position to the structure-covering position onto the structure;
a cover-following lifting mechanism coupled to a leading section of the weather protective cover, and structured to follow movement of the weather protective cover as the weather protective cover is being moved by the means for moving; and
the cover-following lifting mechanism being structured to raise at least the leading section of the weather protective cover to a height greater than the prescribed height as portions of the weather protective cover are moved over the structure.

15. The weather protection system as set forth in claim 14, which further comprises:
a storage container for storing the weather protective cover in the structure-uncovering position.

16. The weather protection system as set forth in claim 14, which further comprises:
a rigid bar attached to at least a portion of the leading section of the weather protective cover;
a pivot member fixedly mounted on a portion of the rigid bar, and having a support section extending outward from the rigid bar;
the cover-following lifting mechanism having a portion mounted on the support section of the pivot member; and
means for allowing movement of the cover-following lifting mechanism about the support section and relative to the rigid bar while the portion of the cover-following lifting mechanism is mounted on the support section.

17. A weather protection system for use with a structure to be shielded from adverse weather conditions, which comprises:
a weather protective cover locatable onto the structure;
a lip receptor mounted fixedly adjacent, and spaced from at least a portion of, the structure;
a locking lip formed continuously along at least a portion of a side edge of the weather protective cover; and
the locking lip being locatable within the lip receptor to removably retain the at least a portion of the side edge with the fixedly mounted lip receptor.

18. The weather protection system as set forth in claim 17, which further comprises:
means for moving the weather protective cover from a structure-uncovering position to a structure-covering position onto the structure;
a cover-following lifting mechanism coupled to a leading section of the weather protective cover, and structured to follow movement of the weather protective cover as the weather protective cover is being moved by the means for moving; and
the cover-following lifting mechanism being structured to raise at least the leading section of the weather protective cover above the structure as the weather protective cover is moved over the structure.

19. The weather protection system as set forth in claim 17, wherein the lip receptor comprises:
a longitudinal sleeve; and
a longitudinal slit formed in the sleeve, through which the locking lip of the weather protective cover is inserted to removably retain the side edge of the weather protective cover with the fixedly mounted lip receptor.

20. The weather protection system as set forth in claim 18, wherein the locking lip comprises:
a strip integrally formed along an inboard edge thereof with, and extending longitudinally along, a contiguous portion of the weather protective cover;
the strip being folded laterally along the inboard edge and over an adjacent surface of the contiguous portion of the weather protective cover;
the strip assuming a normal position, where the strip is angularly displaced from the adjacent surface of the contiguous portion of the weather protective cover by a prescribed locking angle; and
the strip being bendable from the normal position toward the adjacent surface of the contiguous portion of the weather protective cover upon application of an outside force, and biased to return to the normal position when the outside force is removed.
